(19) United States
(12) Patent Application Publication
(10) Pub. No.: US 2005/0011564 A1
(43) Pub. Date: Jan. 20, 2005

(54) Control plate for an automatic gearbox and method of production of a control plate

(75) Inventors: Michael Baraga, Stuttgart (DE); Tobias Goedecke, Kernen (DE); Gerhard Oettinger, Besigheim (DE); Uwe Pfister, Leutenbach (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/861,913

(22) Filed: Jun. 7, 2004

(30) Foreign Application Priority Data
Jun. 7, 2003 (DE) 103 25 984.8

(51) Int. Cl. F16K 31/02

(52) U.S. Cl. 137/884

(57) ABSTRACT

The invention relates to a control plate of an automatic gearbox, which plate comprises two housing parts and a steel sealing plate clamped in between in a sealing manner by means of screws. In order to keep the manufacturing spread of the tightening torque of these screws small, the screws are tightened until beyond their R_{P 0.2} limit in a manner controlled by the angle of rotation.

This application claims the priority of German Patent Document No. 103 25 984.8, filed Jun. 7, 2003, the disclosure of which is expressly incorporated by reference herein.

### BACKGROUND AND SUMMARY OF THE INVENTION

The invention relates to a control plate for an automatic gearbox and to a method of production for a control plate of an automatic gearbox.

DE 43 44 584 C2 has already disclosed a control plate of an automatic gearbox, which plate is composed of a housing lower part, a housing upper part and a plate arranged between the housing lower and upper parts in a sealing manner. These three parts are clamped to one another by means of screws. Hydraulic channels and hydraulic slide valves' are arranged in the control plate. The hydraulic slide valves are used to distribute the hydraulic flows and pressures to the hydraulic channels and ultimately to the various clutches and brakes of an automatic planetary gearbox. The division into two control-plate housing halves which are sealed off from each other by means of the plate permits an extremely complex control of the hydraulic flow.

With falling costs for standard components, there is a tendency to use screws of ever higher quality.

It is an object of the invention to produce a very high piece number of gearboxes in a failure-proof manner with the use of a lightweight material.

In a particularly advantageous manner, the present invention allows the manufacturing spread of the tightening force of the screws to be minimized both in respect of an individual control plate and also in respect of the entire number of control plates produced.

The control plate can be produced in a particularly advantageous manner from a lightweight, not very stiff, material, such as aluminium or magnesium. In addition to the advantage in terms of weight, these lightweight materials also have the advantage of making it easy for the very complex geometries of a control plate to be machined. In order to prevent the bores for receiving the hydraulic slide-valve pistons from being deformed when the screws are tightened, contrary to current trends, use is made of very soft screws which are stretched beyond their R_{P 0.2} limit. The R_{P 0.2} limit is defined, inter alia, in “W. Beitz, Dubbel, 17th edition, Springer-Verlag, p. E21” as the region in which an elongation of 0.2% remains in the material. Accordingly, the technically measurable parameter is therefore specified from when the material passes from the elastically deformed region into the plastically deformed region. Since the stress-strain profile is substantially flatter above the R_{P 0.2} limit, the stress of the screws and therefore the prestress under which the plate is clamped between the two housing parts of the control plate can be set very precisely. The manufacturing spread of the many screws of a control plate, but also the manufacturing spread of the entire production of the control plate is therefore advantageously very small.

In a particularly advantageous manner, the tightening of the screws over the R_{P 0.2} limit takes place in a manner controlled by the angle of rotation. In comparison with a torque-controlled tightening of the screws, neither
the greatly fluctuating friction between the screw head and screw head support nor
the greatly fluctuating friction in the threads of the screws
   enter to a substantial extent into the tolerance chain. In this case, the thread friction always has an effect on the torsion and therefore on the multiaxial state of stresses of the screw.

Furthermore, the screws can advantageously be tightened more rapidly when controlled by the angle of rotation than when controlled by torque. Manufacturing advantages are therefore obtained in particular for high piece numbers of control plates.

As a consequence of the small manufacturing spread, the prestress exerted by the screws on the two housing parts and on the plate clamped in between, in order to position the plate in a sealing manner, can be kept small. This is associated with advantages in respect of a small plastic deformation of the two very lightweight and soft housing halves. The holes which receive the hydraulic slide-valve pistons are therefore not deformed either. This ensures that the hydraulic slide-valve pistons run smoothly in the holes. This also ensures a low amount of wear and therefore low leakage losses over a long service life of the control plate.

The R_{P 0.2} limit can be exceeded by screws of small diameter being used. Further, the R_{P 0.2} limit can be exceeded in a particularly advantageous manner by using screws having a low permanent elongation limit or strength. If the R_{P 0.2} limit is exceeded as a consequence of using screws of low strength, then, in a particularly advantageous manner, screws of relatively large diameter can be used, this affording the advantage in mass production of being able to use large fracture-proof tools which, in comparison with filigree tools, provide a high degree of reliability against a production breakdown with the correspondingly high costs. Screws having a large diameter also have a large head, so that the force is also distributed over a relatively large surface area, which means that the stresses in the material of the housing part are small.

Screws having low strength are particularly cost-effective, since many screws are screwed to the control plate in order to uniformly distribute the pressure.

As an alternative, screws of a different material than steel may also be used. The material of the screws can thus pass, even at small stresses, from the elastically deformed region into the plastically deformed region by using screws of lightweight material, such as aluminium. These screws also have the advantage of a low weight.

Since the tightening of the screws that is controlled by the angle of rotation is independent of the friction between the screw head and the screw head support, washers can be omitted in the screw connection according to the invention of the screw plate.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an automatic gearbox with a control plate.

FIG. 2 shows a housing lower part of a control plate in a plan view.

FIG. 3 shows a section through the control plate in the region of two hydraulic slide valves.

### DETAILED DESCRIPTION OF THE DRAWINGS

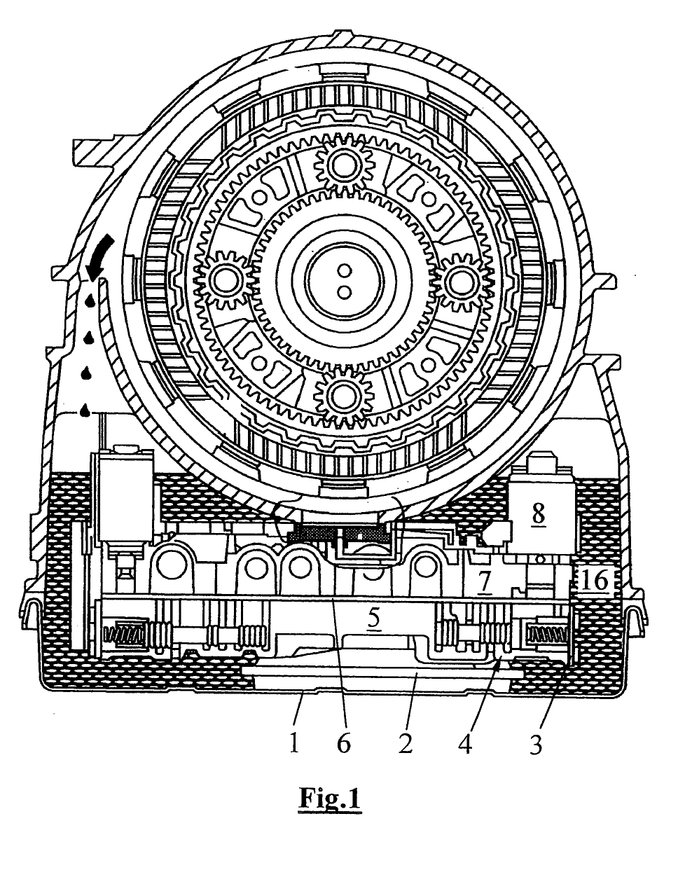

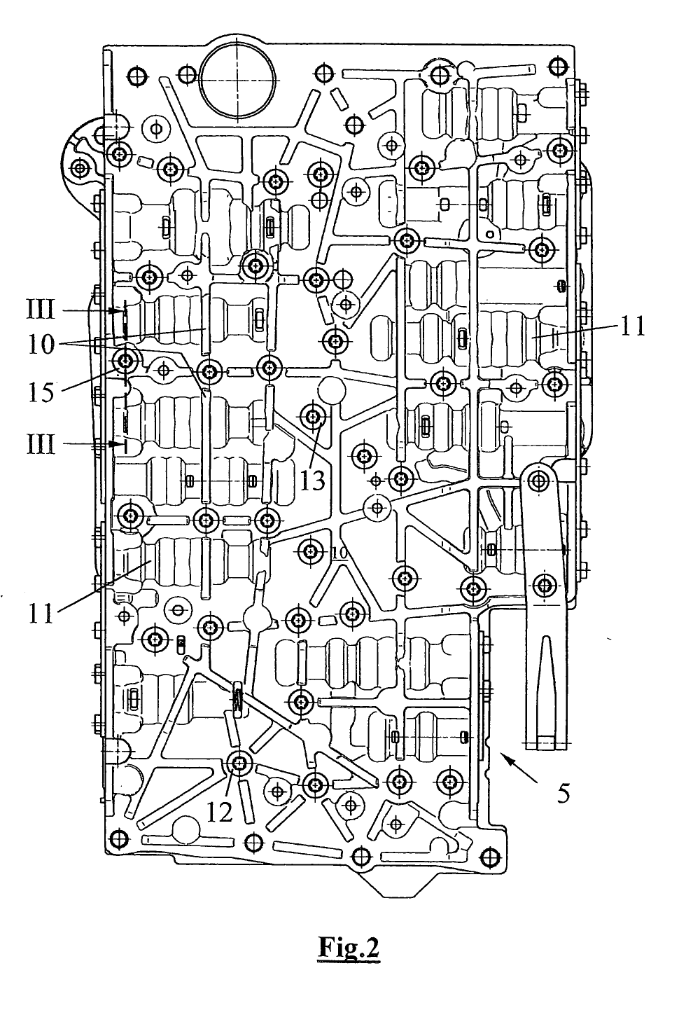

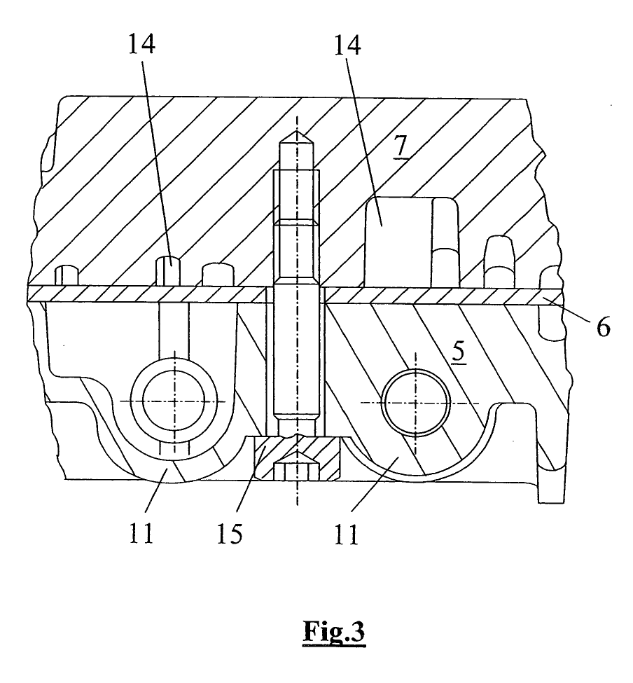

FIG. 1 shows an automatic gearbox in a section perpendicular with respect to its longitudinal axis. Arranged below the planetary gear trains is a control plate in which a housing lower part 5, a housing upper part 7 and a plate 6 arranged in a sealing manner in between are clamped to one another with a plurality of screws which can be seen in FIG. 2 and FIG. 3. The housing lower part 5 bears hydraulic slide valves 4 for controlling the working pressure, and the housing upper part 7 bears proportional control solenoid valves or alternatively pulse-width-modulated valves 8 for controlling the modulating pressure. The housing lower part 5 and the housing upper part 7 is made of an aluminium diecasting, whereas the plate 6 clamped between them is made of a steel plate having a thickness of about 2 mm. Openings in the plate 6 produce the required line connections and the passage for the screws. The hydraulic slide valves 4 are supported on the end side via helical compression springs on end plates 3 which are screwed to the housing lower part 5.

The control plate is surrounded by oil 16. An oil filter 2 and an electric set are fastened to the control plate. The gearbox housing is closed on the lower side by an oil sump 1.

The rear sides of the two housing parts 5, 7 are provided with a multiplicity of ribs 10, which can be seen in FIG. 2, in order, at a low weight, to increase the stiffness of the housing parts 5, 7 and therefore to keep the elastic deformation due to pressures and external forces as small as possible.

FIG. 2 shows the housing lower part 5 of the control plate of an automatic gearbox similar to that from FIG. 1. In addition to the said ribs 10, the housing lower part 5 shows a multiplicity of housing indentations 11 in which the holes of the hydraulic slide valves 4 are incorporated.

FIG. 3 shows a detail of the entire control plate in accordance with the line III-III from FIG. 2. A multiplicity of screws having mechanically rapidly screwable torx heads are pushed through passage holes in the housing lower part 5 and apertures in the plate 6 and are screwed to the housing upper part 7 in threaded blind holes thereof. In this case,
at least one,
generally two or
even three
   screws are always arranged between two hydraulic slide valves 4, so that the pressure in the region of the holes in these hydraulic slide valves 4 is distributed uniformly. This ensures that the holes remain round. In this case, apertures in the ribs 10 oriented perpendicularly to the control plate are provided for the screws, so that the stresses as a consequence of the screwing are distributed over the ribs 10 and hardly cause any sag in the soft housing lower part 5. In order to reinforce this stress-distributing effect and to distribute the stresses over the two surface dimensions of the housing lower part 5, the apertures and the screws are preferably arranged in the intersection region of the ribs 10, as can be seen, for example, with reference to the screw 12. Some of the screws are arranged for the very purpose of this distribution of stresses in the corners of the spaces which are formed between the ribs 10. This can be seen, for example, with reference to the screw 13.

FIG. 3 shows the hydraulic channels 14 which are cast recesses of the housing upper part 7. The screw 15 is arranged between the two housing indentations 11 and clamps the two housing parts 5, 7 to each other with the interconnection of the plate 6. This screw 15 is—like the other screws—tightened beyond its R_{P 0.2} limit in a manner controlled by the angle of rotation. In this case, the torx head of the screw 15 bears directly against the housing upper part 7 without a washer.

The automatic gearbox can be any desired gearbox having gearbox components which are actuated by an auxiliary force. For example, the automatic gearbox may be
an automatic planetary gearbox,
an automated countershaft gearbox,
a double clutch gearbox,
a belt and pulley contact gearbox or
a toroidal gearbox.

Depending on the type of gearbox, the gearbox components which are activated by the control plate are
starting and release clutches, such as dry or wet clutches,
gear-changing clutches, such as dog clutches and synchromeshes,
multi-disc clutches,
multi-disc brakes,
a parking brake,
conical-disc variators or
toroidal variators.

It is also possible for any other desired lightweight material to be provided as the particularly lightweight—and therefore generally not very stiff—material. For example, a magnesium alloy may also be used for the control plate. Similarly, a plastic, such as, for example, a fibre-reinforced duroplastic or a thermoplastic can be used. Internally threaded sleeves which receive the said screws can be inserted into said plastics.

The embodiments which are described are only exemplary designs. A combination of the described features for different embodiments is likewise possible. Further features, in particular features which are not described, of the device parts belonging to the invention can be gathered from the geometries of the device parts that are illustrated in the drawings.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A control plate of an automatic gearbox with hydraulic channels, comprising:
a housing lower part;
a housing upper part;
a sealing plate arranged in a sealing manner between the housing lower and upper parts; and
a plurality of screws, wherein the housing lower and upper parts and sealing plate can be clamped to one another by the screws, and wherein the screws are tightened beyond their R_{P 0.2} limit in a manner controlled by angle of rotation or yield-controlled.

2. The control plate according to claim 1, further comprising hydraulic slide valves.

3. The control plate according to claim 2, wherein the sealing plate bears in a sealing manner against the housing upper part and against the housing lower part.

4. The control plate according to claim 3, wherein the screws are not tempered.

5. The control plate according to claim 4, wherein at least one of the two housing parts has ribs on the outside for reinforcing the at least one housing part.

6. The control plate according to claim 5, wherein the at least one housing part includes an aperture in one of the ribs, and wherein at least one of the screws is arranged in a region of the aperture.

7. The control plate according to claim 6, wherein the aperture is arranged in an abutment region of at least three ribs converging together.

8. The control plate according to claim 5, wherein the screw head of at least one of the screws is arranged in a corner of a space which is formed between the ribs.

9. The control plate according to claim 1, wherein the sealing plate bears in a sealing manner against the housing upper part and against the housing lower part.

10. The control plate according to claim 1, wherein the screws are not tempered.

11. The control plate according to claim 1, wherein at least one of the two housing parts has ribs on the outside for reinforcing the at least one housing part.

12. The control plate according to claim 11, wherein the at least one housing part includes an aperture in one of the ribs, and wherein at least one of the screws is arranged in a region of the aperture.

13. The control plate according to claim 12, wherein the aperture is arranged in an abutment region of at least three ribs converging together.

14. The control plate according to claim 11, wherein the screw head of at least one of the screws is arranged in a corner of a space which is formed between the ribs.

15. A method of production for a control plate of an automatic gearbox with hydraulic channels, the method comprising the steps of clamping a sealing plate of the control plate in a sealing manner between housing lower and upper parts of the control plate with screws, and tightening the screws beyond their R_{P 0.2} limit in a manner controlled by the angle of rotation or yield-controlled.
